(19) United States
(12) Patent Application Publication
(10) Pub. No.: US 2026/0211478 A1
(43) Pub. Date: Jul. 23, 2026

(54) REGION-LEVEL POWER MANAGEMENT FOR RECONFIGURABLE LOGIC DEVICES

(71) Applicant: Aivres Systems Inc., Fremont, CA (US)

(72) Inventor: Yu Yang YANG, New Taipei City (TW)

(21) Appl. No.: 19/563,806

(22) Filed: Mar. 11, 2026

(51) Int. Cl. G06F 1/3228

(52) U.S. Cl. CPC G06F 1/3228

(57) ABSTRACT

A computing system includes a reconfigurable logic device having a plurality of reconfigurable regions, a PMIC configured to independently control power to respective reconfigurable regions, and a controller coupled to the PMIC. The controller determines, based on at least one of a task indication, a workload condition, or a control command, a subset of the reconfigurable regions to be powered, and causes the PMIC to supply power to each reconfigurable region in the subset and to withhold power from at least one reconfigurable region outside the subset. In some implementations, the controller selects a configuration bitstream associated with a target task and determines the subset based on the bitstream. The system may use sensor telemetry and device-reported task status to update the subset during operation.

### TECHNICAL FIELD

The present disclosure relates to programmable and reconfigurable computing hardware. More particularly, the present disclosure relates to power management and task-aware power control for reconfigurable logic devices having multiple reconfigurable regions, such as field-programmable gate arrays (FPGAs).

### BACKGROUND

Reconfigurable logic devices, including FPGAs and other programmable logic devices, are widely used to implement hardware-accelerated functions in communications, artificial intelligence, industrial control, and edge computing. A key advantage of such devices is their ability to be configured to perform different tasks by loading different configuration data (e.g., bitstreams). However, many systems power the reconfigurable logic device as a largely monolithic power domain during configuration and operation. Even when only a portion of the device is needed for a given task, unused logic regions may remain powered, resulting in unnecessary static leakage and dynamic switching power.

Certain FPGA platforms support partial reconfiguration, which can update a portion of the device while other portions remain in operation. In practice, configuration control and power control are often implemented as separate functions, for example by using an external host processor for bitstream selection and configuration control, and a separate power management integrated circuit (PMIC) that supplies fixed voltages to the device. Because configuration control and power control are not coordinated at a fine granularity, these systems may keep non-required regions powered during task execution and during reconfiguration events. This separation can increase energy consumption, increase heat generation, and reduce responsiveness during frequent task switching, particularly in power-constrained and real-time environments such as IoT nodes, wearable devices, and edge inference systems.

Accordingly, there is a need for improved architectures that enable task-aware, region-level power management in reconfigurable logic devices, so that power can be supplied to regions that are required for a task and withheld from regions that are not required, thereby improving energy efficiency and system responsiveness.

### SUMMARY

A system of one or more computers can be configured to perform particular operations or actions by virtue of having software, firmware, hardware, or a combination thereof installed on the system that, in operation, causes the system to perform the actions. One or more computer programs can be configured to perform particular operations or actions by including instructions that, when executed by data processing apparatus, cause the apparatus to perform the actions.

In one general aspect, a computing system includes a reconfigurable logic device comprising a plurality of reconfigurable regions. The computing system further includes a PMIC coupled to the reconfigurable logic device and configured to independently control power to respective ones of the plurality of reconfigurable regions. The computing system further includes a controller coupled to the PMIC. The controller is configured to: determine, based on at least one of a task indication, a workload condition, or a control command, a subset of the plurality of reconfigurable regions to be powered; and cause the PMIC to supply power to each reconfigurable region in the subset and to withhold power from at least one reconfigurable region outside the subset. Other embodiments of this aspect include corresponding computer systems, apparatus, and computer programs recorded on one or more computer storage devices, each configured to perform the described actions.

Implementations may include one or more of the following features. In some implementations, the reconfigurable logic device comprises a field-programmable gate array (FPGA). In some implementations, the controller comprises a complex programmable logic device (CPLD). In some implementations, the PMIC comprises a plurality of controllable power outputs respectively associated with the plurality of reconfigurable regions. In some implementations, the PMIC is configured to output a power-good indication for a reconfigurable region after a power rail for the reconfigurable region satisfies a stability criterion, and the controller is configured to delay loading configuration data for the reconfigurable region until receipt of the power-good indication. In some implementations, the controller is configured to: determine, based on a target configuration bitstream associated with a target task, an initial subset of the plurality of reconfigurable regions to be powered; and, during execution of the target task, refine the initial subset based on telemetry data by causing the PMIC to withhold power from at least one reconfigurable region included in the initial subset. In some implementations, to determine the subset of the plurality of reconfigurable regions to be active, the controller is configured to: determine a target task based on a predefined task list stored in a non-volatile configuration memory accessible to the controller or based on an external command received by the controller; select a target configuration bitstream associated with the target task; determine, based on the target configuration bitstream, the subset of the plurality of reconfigurable regions; and load the target configuration bitstream to the reconfigurable logic device. In some implementations, the controller is coupled to the reconfigurable logic device via an inter-integrated circuit (I²C) interface or a serial peripheral interface (SPI), and the controller is configured to: determine a target task based on task status information received from the reconfigurable logic device via the I²C interface or the SPI; select a target configuration bitstream associated with the target task; determine, based on the target configuration bitstream, the subset of the plurality of reconfigurable regions; and load the target configuration bitstream to the reconfigurable logic device. In some implementations, the computing system includes one or more sensors configured to provide telemetry data including at least one of current or temperature associated with the reconfigurable logic device, and the controller is configured to determine the subset of the plurality of reconfigurable regions based on the telemetry data. In some implementations, the one or more sensors include a plurality of current sensors respectively associated with the plurality of reconfigurable regions, and the controller is configured to determine, based on region-level current values from the plurality of current sensors, whether to power a respective reconfigurable region. In some implementations, the one or more sensors include a plurality of temperature sensors disposed around a periphery of the reconfigurable logic device, and the controller is configured to determine, based on temperature data from the plurality of temperature sensors, whether the reconfigurable logic device is executing a workload condition indicative of an active task, and to determine the subset of the plurality of reconfigurable regions to be powered based at least in part on the workload condition. In some implementations, the controller is configured to switch from a first subset associated with a first task to a second subset associated with a second task by causing the PMIC to remove power from at least one reconfigurable region in the first subset and to supply power to at least one reconfigurable region in the second subset. In some implementations, the computing system includes a non-volatile configuration memory storing a plurality of configuration bitstreams for the reconfigurable logic device, and the reconfigurable logic device further includes an on-chip configuration cache configured to store one or more configuration fragments associated with at least one of the plurality of configuration bitstreams, wherein the controller is configured, during a task switch, to cause at least one configuration fragment to be loaded from the on-chip configuration cache. Implementations of the described techniques may include hardware, a method or process, or a non-transitory computer-readable medium.

In one general aspect, a computer-implemented method includes determining, by a controller, a target task based on at least one of a task indication, a workload condition, or a control command. The method further includes selecting, by the controller, a target configuration bitstream associated with the target task. The method further includes determining, based on the target configuration bitstream, a subset of a plurality of reconfigurable regions of a reconfigurable logic device to be powered. The method further includes causing, by the controller, a PMIC having a plurality of controllable power outputs respectively associated with the plurality of reconfigurable regions to supply power to each reconfigurable region in the subset and to withhold power from at least one reconfigurable region outside the subset. The method further includes, responsive to receiving a power-good indication for at least one reconfigurable region in the subset, loading at least a portion of the target configuration bitstream to the reconfigurable logic device. Other embodiments of this aspect include corresponding computer systems, apparatus, and computer programs recorded on one or more computer storage devices, each configured to perform the described actions.

Implementations may include one or more of the following features. In some implementations, determining the target task includes determining the target task based on a predefined task list stored in a non-volatile configuration memory accessible to the controller or based on an external command received by the controller. In some implementations, determining the target task includes receiving, from the reconfigurable logic device via an inter-integrated circuit (I²C) interface or a serial peripheral interface (SPI), task status information indicative of the target task. In some implementations, the method further includes: during execution of the target task, receiving telemetry data including at least one of region-level current or temperature associated with the reconfigurable logic device; and, based on the telemetry data, causing the PMIC to withhold power from at least one reconfigurable region included in the subset. Implementations of the described techniques may include hardware, a method or process, or a non-transitory computer-readable medium.

In one general aspect, a non-transitory computer-readable medium stores instructions that, when executed by one or more processors of a controller, cause the controller to perform operations comprising: determining a target task based on at least one of a task indication, a workload condition, or a control command; selecting a target configuration bitstream associated with the target task; determining, based on the target configuration bitstream, a subset of a plurality of reconfigurable regions of a reconfigurable logic device to be powered; causing a PMIC having a plurality of controllable power outputs respectively associated with the plurality of reconfigurable regions to supply power to each reconfigurable region in the subset and to withhold power from at least one reconfigurable region outside the subset; and, responsive to receiving a power-good indication for at least one reconfigurable region in the subset, loading at least a portion of the target configuration bitstream to the reconfigurable logic device. Other embodiments of this aspect include corresponding computer systems, apparatus, and computer programs recorded on one or more computer storage devices, each configured to perform the described operations.

Implementations may include one or more of the following features. In some implementations, determining the target task includes receiving task status information from the reconfigurable logic device via an inter-integrated circuit (I²C) interface or a serial peripheral interface (SPI), and determining the target task based at least in part on the task status information, alone or in combination with telemetry data including at least one of current or temperature associated with the reconfigurable logic device. In some implementations, the operations further include switching from a first task associated with a first configuration bitstream and a first subset of the plurality of reconfigurable regions to a second task associated with a second configuration bitstream and a second subset of the plurality of reconfigurable regions by: causing the PMIC to remove power from at least one reconfigurable region in the first subset; causing the PMIC to supply power to at least one reconfigurable region in the second subset; and loading at least a portion of the second configuration bitstream to the reconfigurable logic device. Implementations of the described techniques may include hardware, a method or process, or a non-transitory computer-readable medium.

### BRIEF DESCRIPTION OF THE DRAWINGS

Certain features of various embodiments of the present technology are set forth with particularity in the appended claims. A better understanding of the features and advantages of the technology will be obtained by reference to the following detailed description that sets forth illustrative embodiments, in which the principles of the disclosure are utilized, and the accompanying drawings of which:

FIG. 1 illustrates an example system architecture of a computing system for task-aware, region-level power management of a reconfigurable logic device, in accordance with some embodiments.

FIG. 2 illustrates an example operational flow for task-aware, region-level power management of a reconfigurable logic device, in accordance with some embodiments.

FIG. 3 illustrates an example region-level power domain implementation for independently controlling power supplied to respective reconfigurable regions of a reconfigurable logic device, in accordance with some embodiments.

FIG. 4 illustrates an example controller decision architecture and an example task-to-bitstream-to-region-subset mapping for determining a subset of reconfigurable regions to be powered for a target task, in accordance with some embodiments.

FIG. 5 illustrates an example method of task-aware, region-level power management of a reconfigurable logic device, in accordance with some embodiments.

FIG. 6 illustrates a block diagram of an example computer system in which various of the embodiments described herein may be implemented.

### DETAILED DESCRIPTION OF EMBODIMENTS

In the following description, certain specific details are set forth in order to provide a thorough understanding of various embodiments of the disclosure. However, one skilled in the art will understand that the disclosure may be practiced without these details. Moreover, while various embodiments of the disclosure are disclosed herein, many adaptations and modifications may be made within the scope of the disclosure in accordance with the common general knowledge of those skilled in this art. Such modifications include the substitution of known equivalents for any aspect of the disclosure in order to achieve the same result in substantially the same way.

Unless the context requires otherwise, throughout the present specification and claims, the word “comprise” and variations thereof, such as, “comprises” and “comprising” are to be construed in an open, inclusive sense, that is as “including, but not limited to.” Recitation of numeric ranges of values throughout the specification is intended to serve as a shorthand notation of referring individually to each separate value falling within the range inclusive of the values defining the range, and each separate value is incorporated in the specification as it were individually recited herein. Additionally, the singular forms “a,” “an” and “the” include plural referents unless the context clearly dictates otherwise.

Reference throughout this specification to “one embodiment” or “an embodiment” means that a particular feature, structure or characteristic described in connection with the embodiment is included in at least one embodiment of the present disclosure. Thus, the appearances of the phrases “in one embodiment” or “in an embodiment” in various places throughout this specification are not necessarily all referring to the same embodiment, but may be in some instances. Furthermore, the particular features, structures, or characteristics may be combined in any suitable manner in one or more embodiments.

In some embodiments, computing systems used in data centers and enterprise servers include one or more reconfigurable logic devices, such as field-programmable gate arrays (FPGAs), to implement hardware-accelerated functions that may be updated after deployment. An FPGA can be configured to implement a selected logic design by loading a configuration bitstream, enabling the same device to support different functions at different times. In some embodiments, such an FPGA is deployed alongside one or more control and management components, such as a complex programmable logic device (CPLD) that performs board-level control functions, and a baseboard management controller (BMC) that provides out-of-band management capabilities for monitoring, logging, remote servicing, and platform coordination. In some embodiments, the CPLD and the BMC interface with other platform circuits, such as power management circuits, sensors, and configuration storage, to coordinate initialization and operation of the FPGA within a server platform.

In some embodiments, power consumption and thermal dissipation of server platforms are driven in part by how power is delivered to configurable devices and to internal portions of such devices. Power delivery can be managed using a power management circuit, such as a power management integrated circuit (PMIC), that controls one or more power rails supplying the reconfigurable logic device and related circuitry. In some embodiments, improving power efficiency of an FPGA or other reconfigurable logic device is beneficial because reduced power draw can reduce heat generation, increase system-level power headroom for other components, and improve performance-per-watt metrics under data-center power and thermal constraints. In some embodiments, region-level control of power delivery within a reconfigurable logic device provides additional opportunities to align powered circuitry with active workloads while maintaining the ability to load and switch among configuration bitstreams under platform control.

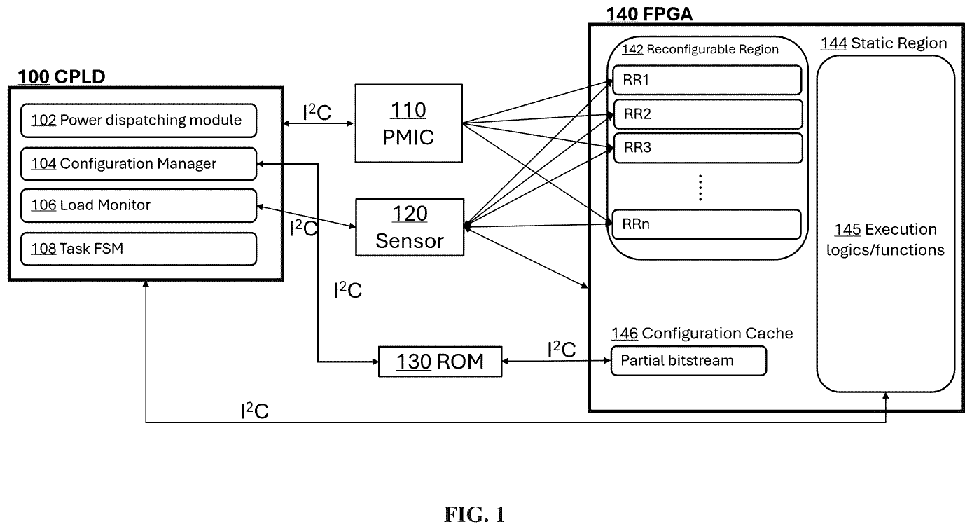

FIG. 1 illustrates an example system architecture of a computing system for task-aware, region-level power management of a reconfigurable logic device, in accordance with some embodiments. In particular, FIG. 1 shows an example system architecture centered on an FPGA 140 that is configured to implement different hardware functions by loading configuration data, and that is organized to support region-level power control. The FPGA 140 includes a reconfigurable region block 142 that is partitioned into multiple reconfigurable regions (RR1, RR2, RR3, . . . RRn). In practice, each reconfigurable region corresponds to a defined portion of the FPGA fabric and is associated with a separately controllable power domain (e.g., a distinct internal power island and/or a separately controlled rail or switch path), so that different portions of the same FPGA device can be powered on or powered off independently rather than treating the entire FPGA as a single always-powered block.

The FPGA 140 may also include a static region 144 that remains powered to provide infrastructure used while the reconfigurable regions 142 are selectively powered and configured. The static region 144 can include, for example, configuration control logic, interface logic, and task-status reporting logic. The reconfigurable regions 142 implement execution logics/functions 145 corresponding to the currently selected workload. For example, in a server platform the FPGA 140 can interface with external components such as a host processor, system memory, a network interface controller, or storage and peripheral controllers, and can be configured to perform functions such as packet processing, encryption/decryption, compression, protocol offload, telemetry processing, or other accelerator functions. When the workload changes, the configured function of the execution logics/functions 145 can change accordingly.

Configuration of the FPGA 140 is performed using a configuration bitstream, where a “bitstream” is configuration data that programs the FPGA fabric to realize a particular hardware design. In the architecture of FIG. 1, a non-volatile configuration memory 130 (e.g., a read-only memory (ROM)) stores multiple bitstreams associated with different tasks. In some embodiments, the FPGA 140 also includes an on-chip configuration cache 146 that stores configuration fragments such as a partial bitstream. The on-chip configuration cache 146 can be used to support faster switching by supplying at least some configuration data from within the FPGA device, which can reduce reconfiguration latency and/or reduce accesses to the non-volatile configuration memory 130 during a task change.

As shown in the illustrated architecture, a controller 100 coordinates both configuration activity and region-level power control. In some embodiments, the controller 100 is implemented as a complex programmable logic device (CPLD) 100, and includes functional logic shown as a power dispatching module 102, a configuration manager 104, a load monitor 106, and a task finite state machine (FSM) 108. The task FSM 108 determines a target task based on one or more inputs such as a task indication, a workload condition, or a control command. The configuration manager 104 selects a target configuration bitstream associated with the target task and coordinates loading of that bitstream to the FPGA 140. The load monitor 106 evaluates operating conditions using telemetry, and the power dispatching module 102 controls which reconfigurable regions (i.e., a subset of the all the reconfigurable regions on the FPGA) are to be powered for the selected task and, when appropriate, which regions are to remain unpowered.

In other words, the controller 100 determines (using its internal components) the subset of reconfigurable regions to be powered using region-allocation information associated with a selected configuration bitstream. In some embodiments, the region-allocation information is encoded as metadata packaged with the configuration bitstream, and the controller 100 parses the metadata to obtain a region identifier set, a region mask, and/or a list of power domains corresponding to reconfigurable regions to be powered for execution of a target task.

In some embodiments, the region-allocation information is stored separately from the configuration bitstream and is indexed by a bitstream identifier, a task identifier, a hash of the configuration bitstream, a version value, or a combination thereof, such that the controller 100 retrieves a corresponding region mask from a non-volatile configuration memory prior to, or concurrently with, loading the configuration bitstream to the reconfigurable logic device.

In some embodiments, the non-volatile configuration memory stores a table mapping each of a plurality of configuration bitstreams (or corresponding task identifiers) to a respective region subset definition, and the controller 100 uses the table to determine which controllable power outputs of the PMIC are to be enabled.

In some embodiments, the region subset definition includes one or more of: a region bitmask; a list of region identifiers; a list of power-rail identifiers; a per-region voltage level; a per-region ramp sequence; or a per-region configuration fragment identifier indicating a portion of the configuration bitstream to be loaded for that region.

In some embodiments, the controller 100 determines an initial subset using the region-allocation information and then refines the initial subset during execution of the target task based on telemetry data by disabling power to at least one reconfigurable region included in the initial subset. In some embodiments, the controller 100 coordinates power sequencing and configuration sequencing on a per-region basis by enabling power to a reconfigurable region, waiting for a power-good indication corresponding to that region, and then loading configuration data for that reconfigurable region, where the configuration data is obtained from the non-volatile configuration memory and/or from an on-chip configuration cache.

In some embodiments, region-level power delivery is provided by a power management integrated circuit (PMIC) 110 coupled to the FPGA 140. The PMIC 110 provides a plurality of controllable power outputs, with respective outputs associated with respective power domains for the reconfigurable regions 142, enabling the controller 100 to supply power to a selected subset of reconfigurable regions and withhold power from at least one region outside that subset. In some embodiments, the PMIC 110 further provides a power-good indication for a given region's power rail after a stability criterion is satisfied (e.g., voltage and/or current settling), and the controller 100 delays loading configuration data for that region until the power-good indication is received.

In some embodiments, the illustrated system further includes one or more sensors 120 that provide telemetry data associated with operation of the FPGA 140. The sensors 120 can include, for example, current sensors and/or temperature sensors. In some embodiments, a plurality of current sensors is associated with respective reconfigurable regions so that region-level current values are available to the controller 100. For example, each reconfigurable region (e.g., RR1-RRn) can be powered through a respective rail, and a current sensor can be placed in the corresponding power distribution path (e.g., in series with the rail, integrated in a PMIC monitor, or implemented using a sense resistor and amplifier) to report a region-level current value. In some embodiments, when a particular bank or region is actively performing logic operations for a task, the measured current remains above an activity threshold (optionally for a threshold duration), and when the bank or region is not actively performing logic operations, the measured current remains below an idle threshold (optionally for a threshold duration). The controller 100 can use such telemetry to assess whether regions are active and to decide whether a region should remain powered, be powered up, or be depowered, including during continued execution of a task or while transitioning between tasks.

FIG. 1 also illustrates example interconnects used for control, configuration, and monitoring. In the illustrated example, inter-integrated circuit (I²C) interfaces may be used for one or more links between the controller 100 and the PMIC 110, the sensor 120, the non-volatile configuration memory 130, and/or the FPGA 140. The same architecture can be implemented with other communication interfaces, including a serial peripheral interface (SPI) and other serial or parallel protocols, depending on platform constraints such as bandwidth, pin count, and latency. Over these interfaces, the FPGA 140 can provide task status information to the controller 100, the controller 100 can retrieve a selected bitstream from the non-volatile configuration memory 130 and transfer configuration data to the FPGA 140, and the controller 100 can command the PMIC 110 to apply or withhold power on a region-by-region basis in coordination with the selected task and sensed operating conditions.

The architecture of FIG. 1 improves power efficiency and task responsiveness by coordinating which regions are powered with which configuration bitstream is active, rather than treating the reconfigurable logic device 140 as a single always-powered block. In particular, the combination of (i) the FPGA 140 being partitioned into separately power-controllable reconfigurable regions 142, (ii) the PMIC 110 providing region-associated controllable power outputs, and (iii) the controller 100 determining a subset of the reconfigurable regions 142 to be powered for a target task enables the system to deliver power only to circuitry expected to participate in the current workload while withholding power from at least one region outside the selected subset. This region-level power selection reduces idle power draw attributable to powered but unused portions of the FPGA 140 and reduces heat generation associated with those portions, which in turn can improve server-level power headroom and thermal margin.

In addition, the architecture improves reliability and transition behavior during task changes by sequencing configuration actions with power-domain readiness. For example, the PMIC 110 can provide a power-good indication for a region once its power rail satisfies a stability criterion, and the controller 100 can delay loading configuration data into that region until the power-good indication is received. This feature reduces the likelihood of configuration operations being applied to inadequately powered circuitry. Further, by using telemetry from sensors 120 (e.g., region-level current sensors and/or temperature sensors), the controller 100 can evaluate workload conditions and adjust region-level power decisions to reflect actual operating behavior, including maintaining power for regions that are active and depowering regions that are not needed. When used in combination with the on-chip configuration cache 146, task switching can be performed with reduced external memory traffic by loading cached configuration fragments, which can reduce reconfiguration latency and allow the system to transition between tasks while keeping power delivery aligned with the selected workload.

In alternative embodiments, the controller 100 is implemented by, or includes, a management controller of a host platform, such as a baseboard management controller (BMC). In such embodiments, the BMC executes control logic corresponding to one or more of the power dispatching module 102, the configuration manager 104, the load monitor 106, and the task finite state machine (FSM) 108, including determining a target task and coordinating region-level power control and configuration loading based on one or more inputs such as a task indication, a workload condition, or a control command.

In some embodiments, the controller 100 is distributed across multiple control elements. For example, a BMC may determine the target task and/or provide control commands and policy inputs (e.g., task requests, thermal limits, power budgets, or service-level constraints), while a CPLD performs time-sensitive operations including asserting region-level power-control signals to the PMIC 110, enforcing power sequencing (including monitoring power-good indications), and coordinating transfer of configuration data to the FPGA 140. In some embodiments, the BMC and CPLD communicate over a management interconnect (e.g., inter-integrated circuit (I²C), serial peripheral interface (SPI), general-purpose input/output (GPIO) signaling, or another serial or parallel interface), and the CPLD applies region-level power updates responsive to commands received from the BMC and/or telemetry received from sensors 120 and/or the FPGA 140.

In some embodiments, the BMC directly controls the PMIC 110 to enable or disable region-associated rails and/or to select per-region voltage levels, and the BMC further coordinates loading of a target configuration bitstream to the FPGA 140, either by directly transferring configuration data or by instructing another device (e.g., the CPLD or a configuration engine) to perform the transfer. In these embodiments, the functional partitioning shown in FIG. 1 is illustrative, and the operations attributed to the controller 100 can be implemented by firmware, software, hardware, or combinations thereof executing on the BMC, the CPLD, one or more processors, or combinations of these components.

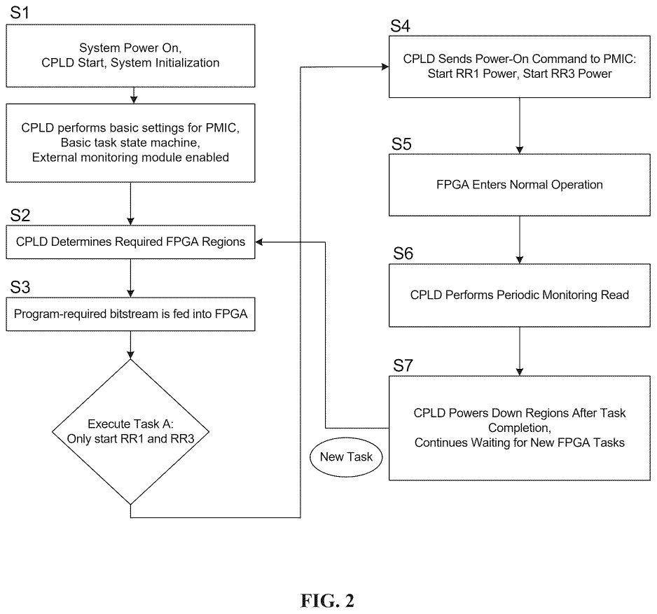

FIG. 2 illustrates an example operational flow for task-aware, region-level power management of a reconfigurable logic device, in accordance with some embodiments. The example flow may be executed by a controller (e.g., a complex programmable logic device (CPLD)) that coordinates both configuration activity and region-level power delivery through a PMIC (e.g., a power management integrated circuit (PMIC)).

At S1, the system powers on and the controller starts and performs initialization. During this initialization, the controller configures baseline settings for the PMIC (e.g., enabling required rails and setting initial voltage levels), initializes internal control logic such as a task state machine, and enables monitoring circuitry used to observe operating conditions of the reconfigurable logic device. In some embodiments, enabling monitoring includes activating one or more sensors that provide telemetry such as current and/or temperature.

At S2, the controller determines which portions of the reconfigurable logic device are required for the next task. This determination can be driven by one or more inputs, including a task indication, a workload condition inferred from telemetry, or a control command. In some embodiments, the controller determines a target task based on a predefined task list stored in a non-volatile configuration memory and/or based on an external command. In some embodiments, the reconfigurable logic device provides task status information to the controller via an inter-integrated circuit (I²C) interface or a serial peripheral interface (SPI), and the controller uses that task status information as at least part of the basis for selecting the target task. In other words, a task indication may be obtained from device-reported task status or a controller-maintained task list; a workload condition may be inferred from telemetry such as current and temperature; and a control command may be received externally (e.g., from a host or BMC) to request or authorize task selection and associated power/configuration actions.

At S3, the controller selects and loads a target configuration bitstream associated with the target task. In some embodiments, the target configuration bitstream is stored in non-volatile configuration memory (e.g., ROM or flash), and the controller retrieves the target configuration bitstream and transfers it to the reconfigurable logic device over a configuration interface (e.g., I²C or SPI). In some embodiments, the target configuration bitstream implies an initial region usage plan for the target task, such that the controller determines, based on the target configuration bitstream, an initial subset of reconfigurable regions that are to be powered for execution of the target task. In some embodiments, at least a portion of the configuration data is obtained from an on-chip configuration cache of the reconfigurable logic device (e.g., cached configuration fragments or a partial bitstream) to reduce the amount of configuration data fetched from off-chip non-volatile memory and to reduce task-switch latency.

The decision diamond shown after S3 illustrates an example task instantiation. In the illustrated example, the system proceeds to execute Task A, and the initial subset of reconfigurable regions to be powered for Task A includes RR1 and RR3, while at least one other region remains unpowered. This illustrates that the controller may determine a subset of reconfigurable regions to be powered that is smaller than the full set of available regions.

At S4, the controller causes the PMIC to apply region-level power consistent with the initial subset. In some embodiments, the controller sends one or more power-on commands to the PMIC to start supplying power to the selected reconfigurable regions (e.g., start RR1 power and start RR3 power), while withholding power from at least one reconfigurable region outside the subset. In some embodiments, the PMIC outputs a power-good indication for each powered region once the corresponding power rail satisfies a stability criterion, and the controller delays loading configuration data for circuitry in a given region until the power-good indication for that region is received.

At S5, after the selected reconfigurable regions have been powered and configured, the reconfigurable logic device enters normal operation and executes the target task using the powered regions. In some embodiments, regions outside the selected subset remain depowered during execution of the target task to reduce power consumption.

At S6, the controller performs periodic monitoring reads while the task is executing. The periodic monitoring reads can include, for example, reading telemetry data indicative of region-level current and/or temperature, and reading task status information reported by the reconfigurable logic device. In some embodiments, the controller uses this monitoring information to evaluate a workload condition and to determine whether the initial subset should be refined during task execution.

In some embodiments, at S6, the controller may be further configured to refine the initial subset of powered regions by using telemetry to depower one or more regions that were initially powered but are determined to be unnecessary for continued execution. For example, after initially powering RR1 and RR3 based on the target configuration bitstream, the controller may determine, based on telemetry such as region-level current values and/or temperature patterns, that RR3 is not contributing to the active workload, and may command the PMIC to withhold power from RR3 while maintaining power to RR1. This refinement reduces power consumption in real time during execution of the target task while preserving operation of the regions that remain required.

At S7, after task completion, the controller causes the PMIC to power down one or more reconfigurable regions associated with the completed task, placing the system into a lower-power state while waiting for a subsequent task. If a new task occurs (as indicated by the “New Task” loop), the flow returns to S2 to determine a new target task, select a corresponding bitstream, determine a new subset of regions to be powered, and apply the corresponding region-level power changes. In some embodiments, switching from a first task to a second task includes removing power from at least one region in a first subset and supplying power to at least one region in a second subset, with the configuration operations for the new task coordinated using the selected bitstream and, where applicable, configuration fragments from the on-chip configuration cache.

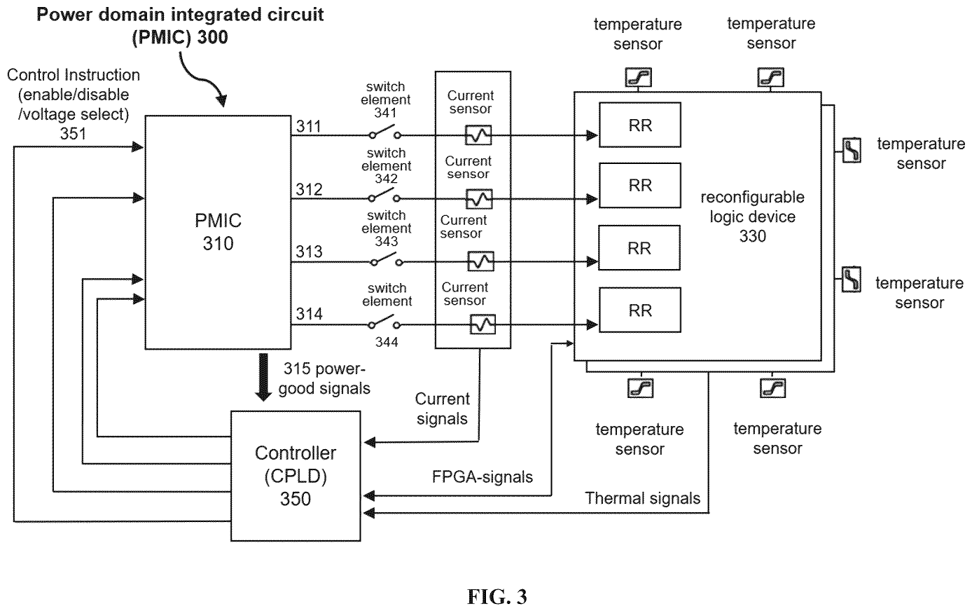

FIG. 3 illustrates an example region-level power domain implementation for independently controlling power supplied to respective reconfigurable regions of a reconfigurable logic device, in accordance with some embodiments.

In the example of FIG. 3, a power domain integrated circuit 300 includes a power management integrated circuit (PMIC) 310 configured to generate and control multiple power rails for a reconfigurable logic device 330. The PMIC 310 provides a plurality of controllable power outputs 311, 312, 313, and 314. Each controllable power output may correspond to a respective power domain intended to supply a respective reconfigurable region (RR) within the reconfigurable logic device 330. A controller 350 (e.g., a complex programmable logic device (CPLD)) provides one or more control instructions 351 to the PMIC 310, where the control instructions 351 may specify, for example, enabling or disabling one or more of the controllable power outputs 311-314 and/or selecting a target voltage, ramp profile, or current limit for a given RR.

Each controllable power output 311-314 is coupled to the reconfigurable logic device 330 through a respective power distribution path that includes a respective switch element 341, 342, 343, or 344. The switch elements 341-344 can be implemented using load switches, high-side power switches, back-to-back field-effect transistors (FETs), power-gating transistors, integrated PMIC load-switch channels, or other controllable switching circuitry. In operation, the PMIC 310 and/or the controller 350 can selectively actuate the switch elements 341-344 (e.g., by asserting a gate-drive or enable signal) to connect or disconnect the corresponding controllable power outputs 311-314 from their associated power domains. This arrangement enables independent depowering of selected regions while maintaining power to other regions of the reconfigurable logic device 330.

In some embodiments, each RR on the reconfigurable logic device 330 corresponds to a hardware-defined portion of the logic device that is associated with a distinct power domain (e.g., a separately switchable rail and/or locally isolated supply network). For example, a first RR may be supplied by controllable power output 311 through switch element 341, while a second RR may be supplied by controllable power output 312 through switch element 342, and so on. In this manner, controller 350 can cause a selected subset of RRs to be powered for a task and can withhold power from at least one RR outside that subset.

FIG. 3 further illustrates example telemetry paths that provide region-level observability to the controller 350. In the illustrated example, one or more current sensors are coupled along the power distribution paths supplying the RRs, and the sensors provide “current signals” to the controller 350. In some embodiments, a current sensor may be implemented as a sense resistor with a differential amplifier, a Hall-effect or magnetoresistive current sensor, a current-mirror based monitor, an inductor DCR measurement circuit, or an integrated current monitor within the PMIC 310. The current signals may be analog (e.g., proportional voltage) and sampled by an analog-to-digital converter (ADC) associated with the controller 350, or may be digitized values delivered over a bus. In some embodiments, the controller 350 samples region-level current periodically and compares measured values to one or more thresholds, profiles, or expected ranges associated with a selected task. The controller 350 may apply filtering and hysteresis (e.g., separate “idle” and “active” thresholds and/or minimum-duration criteria) to avoid rapid toggling of power states.

FIG. 3 also illustrates example temperature sensors disposed around a periphery of the reconfigurable logic device 330, with the sensors providing “thermal signals” to the controller 350. The temperature sensors may be implemented using thermistors, thermal diodes, resistance temperature detectors (RTDs), on-die temperature monitors, or other temperature-sensing circuitry. In some embodiments, the controller 350 uses thermal signals to evaluate a workload condition indicative of whether the reconfigurable logic device 330 is actively executing a task (e.g., sustained temperature rise, localized hot spots, or temperature gradients consistent with activity). The illustrated temperature sensors are provided as an example, and other sensor types and placements may additionally or alternatively be used, including voltage monitors, droop detectors, clock-activity monitors, performance counters, or combinations thereof.

In some embodiments, the reconfigurable logic device 330 provides “FPGA signals” to the controller 350. The FPGA signals can include task-status information, an indication of an upcoming task transition, an identifier of a target task, a health/status report, and/or other self-reporting information generated by logic executing on the reconfigurable logic device 330 (for example, logic in a static region). The FPGA signals may be transmitted using a wired interface (e.g., inter-integrated circuit (I²C), serial peripheral interface (SPI), general-purpose input/output (GPIO), or a dedicated sideband) and may be used alone or in combination with telemetry to determine which RRs should be powered. In some embodiments, the FPGA signals allow the controller 350 to coordinate task switching by preparing power for a next task before or during a reconfiguration operation.

In some embodiments, the controller 350 coordinates configuration loading in addition to power control. For example, after determining a target task, the controller 350 may cause a target configuration bitstream (or a portion thereof) to be loaded to the reconfigurable logic device 330, and may coordinate this loading with power sequencing so that only the RRs needed for the bitstream are powered. In some embodiments, the controller 350 first asserts control instructions 351 to enable and set voltages for the subset of rails associated with the RRs required by the target bitstream, then verifies rail readiness using power-good signaling, and then initiates or permits configuration loading.

FIG. 3 further illustrates a power-good signaling path 315 from the PMIC 310 to the controller 350. In some embodiments, the controller 350 issues control instructions 351 to the PMIC 310 to enable, disable, and/or select an output voltage for one or more of the controllable power outputs 311-314. In response to the control instructions 351, the PMIC 310 performs the requested power action (e.g., soft-start ramp-up, regulation to a programmed setpoint, or controlled ramp-down) and monitors the corresponding rail(s) using internal feedback circuitry. The PMIC 310 asserts a power-good indication 315 after determining that a corresponding rail satisfies a stability criterion, such as the output voltage reaching a programmed setpoint within a tolerance band, remaining within the tolerance band for at least a settling interval, a soft-start ramp completing successfully, and/or an absence of fault conditions (e.g., undervoltage, overvoltage, overcurrent, or thermal shutdown). In some embodiments, the PMIC 310 determines power-good using internal comparators and regulation loops that monitor the regulated output, optionally combined with remote sense feedback at the load, and applies a debounce/qualification timer to avoid asserting power-good during transient conditions. In some embodiments, the PMIC 310 provides power-good on a per-rail basis (e.g., separate indicators corresponding to outputs 311-314) and/or as an aggregated indicator, and FIG. 3 illustrates power-good signaling 315 as one example arrangement.

In some embodiments, the controller 350 uses the power-good signaling 315 as a gating condition that separates power-delivery operations from configuration operations. For example, when a task selection or refinement decision indicates that a given reconfigurable region (RR) of the reconfigurable logic device 330 should be powered, the controller 350 first sends control instructions 351 to enable the associated rail(s) at the PMIC 310 and then waits until the PMIC 310 asserts the corresponding power-good indication 315. After the power-good indication 315 is received, the controller 350 initiates or resumes configuration activity that depends on that region, such as loading at least a portion of a configuration bitstream to the reconfigurable logic device 330, releasing a configuration/reset/isolation condition for the powered region, and/or permitting task execution to proceed. Where a task switch changes the subset of powered RRs, the controller 350 may (i) disable rails for RRs that are not needed by updating control instructions 351, (ii) enable rails for newly required RRs via control instructions 351, (iii) confirm power-good 315 for the newly enabled rails, and then (iv) perform the corresponding configuration loading and/or activation steps for the newly powered RRs.

This sequencing is technically safe because configuration and state transitions that rely on a given RR are not initiated until the PMIC 310 has verified that the corresponding supply rail is in regulation and stable. By gating configuration on the qualified power-good indication 315 (including fault checks and optional debounce), the likelihood of misconfiguration, data corruption, or undefined behavior caused by incomplete rail ramping, droop, or transient fault conditions is reduced.

In some embodiments, the controller 350 performs runtime refinement using telemetry while a task is executing. For example, after powering an initial subset of RRs based on a mapping associated with a target task or bitstream, the controller 350 may continue monitoring current signals and/or thermal signals. If the controller 350 determines that an RR is not being utilized (e.g., sustained low region-level current, temperature behavior inconsistent with activity, and/or FPGA signals indicating non-use), the controller 350 can command the PMIC 310 (via control instructions 351) and/or actuate the corresponding switch element to withhold power from that RR while maintaining power to other RRs that remain required. Conversely, if telemetry or FPGA signals indicate that a previously depowered RR is needed (e.g., due to a task transition), the controller 350 can restore power to that RR, wait for power-good, and coordinate configuration loading as appropriate.

Although FIG. 3 illustrates current sensors and temperature sensors as example telemetry sources, the telemetry circuitry is not limited to these examples. In other embodiments, telemetry can include per-rail voltage measurements, PMIC fault/status registers, activity counters, clock gating indicators, logic utilization metrics, or other signals that can be used to infer whether a workload condition is present and/or whether particular RRs should remain powered.

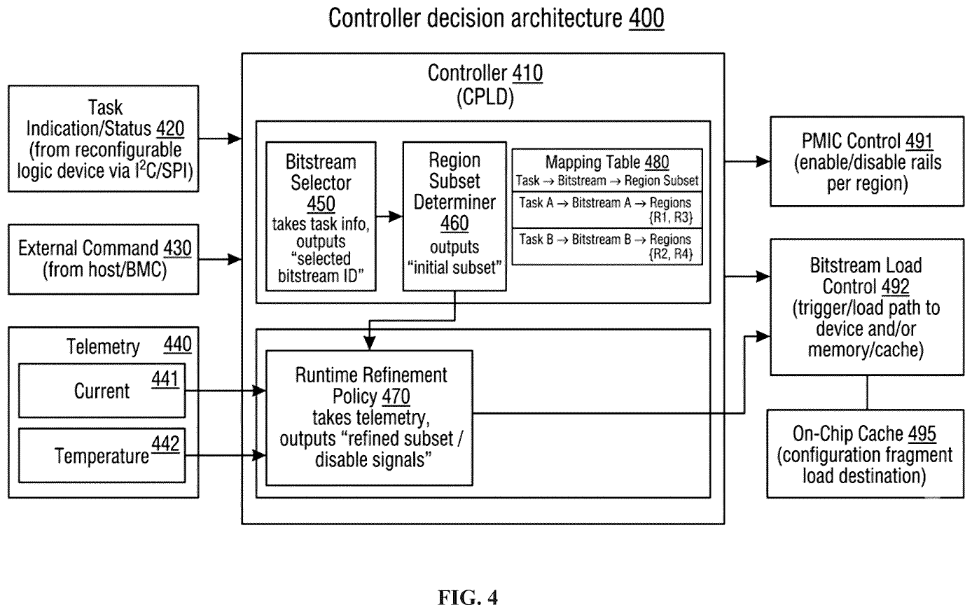

FIG. 4 illustrates an example controller decision architecture and an example task-to-bitstream-to-region-subset mapping for determining a subset of reconfigurable regions to be powered for a target task, in accordance with some embodiments.

In the example of FIG. 4, a controller 410 (shown as a complex programmable logic device (CPLD)) receives multiple categories of inputs that may indicate which task is to be executed and how the reconfigurable logic device is behaving at runtime. A task indication/status input 420 is received from the reconfigurable logic device via an inter-integrated circuit (I²C) interface and/or a serial peripheral interface (SPI). An external command input 430 is received from a host and/or a baseboard management controller (BMC). Telemetry 440 is also provided to the controller 410, and in the illustrated example includes current 441 and temperature 442.

The controller 410 includes a bitstream selector 450 that processes task-related information to select configuration data for the next operation of the reconfigurable logic device. In some embodiments, the bitstream selector 450 receives, as inputs, one or more of: the task indication/status 420 from the reconfigurable logic device, the external command 430, and a locally stored task definition (e.g., a predefined task list maintained in non-volatile memory accessible to the controller). Based on those inputs, the bitstream selector 450 outputs a “selected bitstream ID,” which identifies a target configuration bitstream associated with a target task.

In the example of FIG. 4, the controller 410 further includes a region subset determiner 460 that outputs an “initial subset” of regions to be powered for the selected bitstream. In some embodiments, the region subset determiner 460 uses a mapping table 480 to translate from the target task and/or selected bitstream to a corresponding region subset. The mapping table 480 is illustrated as a {task, bitstream, region subset} relationship, for example: Task A maps to Bitstream A, which maps to regions {R1, R3}; and Task B maps to Bitstream B, which maps to regions {R2, R4}. The mapping table 480 may be implemented in any suitable form, including a lookup table stored in controller-accessible memory, metadata associated with a bitstream, or a data structure generated during a design-time compilation flow and loaded for use by the controller 410.

In some embodiments, the “initial subset” output from the region subset determiner 460 is used to drive two coordinated control paths. First, the controller 410 generates PMIC control 491 to enable and disable region-associated power rails, such that power is supplied to regions in the initial subset and withheld from at least one region outside the initial subset. Second, the controller 410 generates bitstream load control 492 to trigger a configuration load path that transfers the selected bitstream (or portions thereof) to the reconfigurable logic device. In some embodiments, the configuration load path retrieves the selected bitstream from non-volatile configuration memory (e.g., ROM or flash) and transfers the selected bitstream to the device over I²C and/or SPI. In some embodiments, the configuration load path additionally or alternatively stages at least a portion of the configuration data through an on-chip cache.

In the example of FIG. 4, an on-chip cache 495 is shown as a configuration fragment load destination. In some embodiments, the on-chip cache 495 stores one or more configuration fragments associated with one or more bitstreams (e.g., partial bitstreams corresponding to frequently used tasks or frequently switched regions). During a task switch, the controller 410 can cause at least one configuration fragment to be loaded from the on-chip cache 495, either in place of retrieving that fragment from non-volatile memory or in combination with retrieving other portions of the bitstream from non-volatile memory. This arrangement can reduce reconfiguration latency and reduce external memory access bandwidth during task switching.

FIG. 4 also illustrates runtime refinement based on telemetry. In the illustrated example, the controller 410 includes a runtime refinement policy 470 that takes telemetry 440 (including current 441 and temperature 442) as input and outputs “refined subset/disable signals.” In some embodiments, after the initial subset is determined from the mapping table 480 and the corresponding regions are powered, the runtime refinement policy 470 evaluates telemetry patterns to determine whether one or more regions in the initial subset can be depowered without disrupting the task. For example, if a region in the initial subset exhibits sustained low current draw and/or a temperature pattern consistent with inactivity relative to other active regions, the runtime refinement policy 470 can output a disable signal that causes PMIC control 491 to withhold power from that region even though it was included in the initial subset. This makes the initial subset a starting point that can be refined during execution of the target task based on measured operating conditions.

In some embodiments, task switching is performed by repeating the decision sequence for a new target task. For example, when the task indication/status 420 and/or external command 430 indicates a new task, the bitstream selector 450 selects a new bitstream ID, the region subset determiner 460 determines a new region subset using the mapping table 480, and the controller 410 updates PMIC control 491 such that at least one region previously powered is depowered and at least one region required for the new task is powered. The controller 410 also updates bitstream load control 492 to load the new bitstream to the reconfigurable logic device, including optionally loading one or more cached configuration fragments from the on-chip cache 495.

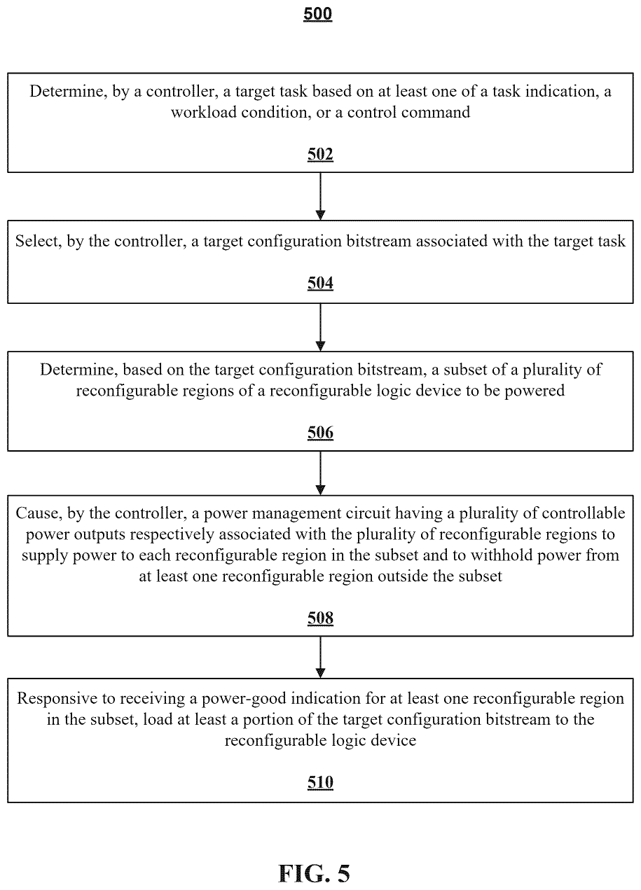

FIG. 5 is a flowchart of an example process 500 for task-aware, region-level power management of a reconfigurable logic device, in accordance with some embodiments. In some implementations, one or more blocks of FIG. 5 are performed by a controller of a computing system.

As shown in FIG. 5, process 500 includes determining, by the controller, a target task based on at least one of a task indication, a workload condition, or a control command (block 502). In some implementations, the task indication is received from a reconfigurable logic device, and the control command is received from a host and/or a baseboard management controller (BMC).

Process 500 further includes selecting, by the controller, a target configuration bitstream associated with the target task (block 504). In some implementations, the target configuration bitstream is retrieved from a non-volatile configuration memory accessible to the controller.

Process 500 further includes determining, based on the target configuration bitstream, a subset of a plurality of reconfigurable regions of a reconfigurable logic device to be powered (block 506). In some implementations, the target configuration bitstream includes or is associated with mapping information that identifies which reconfigurable regions are to be powered for execution of the target task.

Process 500 further includes causing, by the controller, a PMIC having a plurality of controllable power outputs respectively associated with the plurality of reconfigurable regions to supply power to each reconfigurable region in the subset and to withhold power from at least one reconfigurable region outside the subset (block 508). In some implementations, supplying power includes enabling one or more power rails and, optionally, selecting an output voltage for at least one of the power rails.

Process 500 further includes, responsive to receiving a power-good indication for at least one reconfigurable region in the subset, loading at least a portion of the target configuration bitstream to the reconfigurable logic device (block 510). In some implementations, the controller delays loading configuration data for a reconfigurable region until the corresponding power-good indication indicates that a power rail for the reconfigurable region satisfies a stability criterion.

Although FIG. 5 shows example blocks of process 500, in some implementations process 500 includes additional blocks, fewer blocks, different blocks, or differently arranged blocks than those depicted in FIG. 5. Additionally, or alternatively, two or more blocks of process 500 may be performed in parallel.

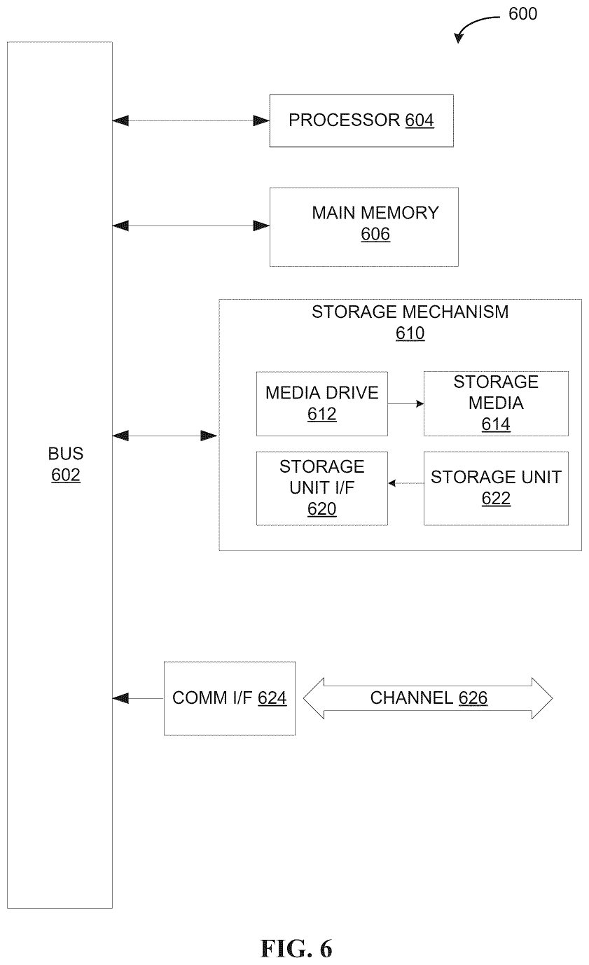

FIG. 6 illustrates an example computing system 600 that may be used in implementing various features of embodiments of the disclosed technology.

As used herein, the term module might describe a given unit of functionality that can be performed in accordance with one or more embodiments of the present application. As used herein, a module might be implemented utilizing any form of hardware, software, or a combination thereof. For example, one or more processors, controllers, ASICs, PLAs, PALs, CPLDs, FPGAs, logical components, software routines or other mechanisms might be implemented to make up a module. In implementation, the various modules described herein might be implemented as discrete modules or the functions and features described can be shared in part or in total among one or more modules. In other words, as would be apparent to one of ordinary skill in the art after reading this description, the various features and functionality described herein may be implemented in any given application and can be implemented in one or more separate or shared modules in various combinations and permutations. Even though various features or elements of functionality may be individually described or claimed as separate modules, one of ordinary skill in the art will understand that these features and functionality can be shared among one or more common software and hardware elements, and such description shall not require or imply that separate hardware or software components are used to implement such features or functionality.

Where components or modules of the application are implemented in whole or in part using software, in one embodiment, these software elements can be implemented to operate with a computing or processing module capable of carrying out the functionality described with respect thereto. One such example computing module is shown in FIG. 6. Various embodiments are described in terms of this example-computing module 600. After reading this description, it will become apparent to a person skilled in the relevant art how to implement the application using other computing modules or architectures.

Referring now to FIG. 6, computing module 600 may represent, for example, computing or processing capabilities found within desktop, laptop, notebook, tablet, cloud and edge, computers; hand-held computing devices (tablets, PDA's, smart phones, cell phones, palmtops, etc.); mainframes, supercomputers, workstations or servers; or any other type of special-purpose or general-purpose computing devices as may be desirable or appropriate for a given application or environment. Computing module 600 might also represent computing capabilities embedded within or otherwise available to a given device. For example, a computing module might be found in other electronic devices such as, for example, digital cameras, navigation systems, cellular telephones, portable computing devices, modems, routers, WAPs, terminals and other electronic devices that might include some form of processing capability.

Computing module 600 might include, for example, one or more processors, controllers, control modules, or other processing devices, such as a processor 604. Processor 604 might be implemented using a general-purpose or special-purpose processing engine such as, for example, a microprocessor, controller, or other control logic. In the illustrated example, processor 604 is connected to a bus 602, although any communication medium can be used to facilitate interaction with other components of computing module 600 or to communicate externally. The bus 602 may also be connected to other components such as a display, input devices, or cursor control to help facilitate interaction and communications between the processor and/or other components of the computing module 600.

Computing module 600 might also include one or more memory modules, simply referred to herein as main memory 606. For example, preferably random-access memory (RAM) or other dynamic memory might be used for storing information and instructions to be executed by processor 604. Main memory 606 might also be used for storing temporary variables or other intermediate information during execution of instructions to be executed by processor 604. Computing module 600 might likewise include a read only memory (“ROM”) or other static storage device 610 coupled to bus 602 for storing static information and instructions for processor 604.

Computing module 600 might also include one or more various forms of storage devices 610, which might include, for example, a media drive 612 and a storage unit interface 620. The media drive 612 might include a drive or other mechanism to support fixed or removable storage media 614. For example, a hard disk drive, a floppy disk drive, a magnetic tape drive, an optical disk drive, a CD, DVD or Bluray drive (R or RW), or other removable or fixed media drive 612 might be provided. Accordingly, storage media 614 might include, for example, a hard disk, a floppy disk, magnetic tape, cartridge, optical disk, a CD or DVD, or other fixed or removable medium that is read by, written to or accessed by media drive 612. As these examples illustrate, the storage media 614 can include a computer usable storage medium having stored therein computer software or data.

In alternative embodiments, storage devices 610 might include other similar instrumentalities for allowing computer programs or other instructions or data to be loaded into computing module 600. Such instrumentalities might include, for example, a fixed or removable storage unit 622 and a storage unit interface 620. Examples of such storage units and storage unit interfaces can include a program cartridge and cartridge interface, a removable memory (for example, a flash memory or other removable memory module) and memory slot, a PCMCIA slot and card, and other fixed or removable storage units and interfaces that allow software and data to be transferred from the storage unit to computing module 600.

Computing module 600 might also include a communications interface 624 or network interface(s). Communications or network interface(s) interface 624 might be used to allow software and data to be transferred between computing module 600 and external devices. Examples of communications interface or network interface(s) might include a modem or soft modem, a network interface (such as an Ethernet, network interface card, WiMedia, WiFi, IEEE 602.XX or other interface), a communications port (such as for example, a USB port, IR port, RS232 port Bluetooth® interface, or other port), or other communications interface. Software and data transferred via communications or network interface(s) might typically be carried on signals, which can be electronic, electromagnetic (which includes optical) or other signals capable of being exchanged by a given communications interface. These signals might be provided to communications interface via a channel 626. This channel might carry signals and might be implemented using a wired or wireless communication medium. Some examples of a channel might include a phone line, a cellular link, an RF link, an optical link, a network interface, a local or wide area network, and other wired or wireless communications channels.

In this document, the terms “computer program medium” and “computer usable medium” are used to generally refer to transitory or non-transitory media such as, for example, memory 606, ROM, and storage unit interface 620. These and other various forms of computer program media or computer usable media may be involved in carrying one or more sequences of one or more instructions to a processing device for execution. Such instructions embodied on the medium, are generally referred to as “computer program code” or a “computer program product” (which may be grouped in the form of computer programs or other groupings). When executed, such instructions might enable the computing module 600 to perform features or functions of the present application as discussed herein.

The performance of certain of the operations may be distributed among the processors, not only residing within a single machine, but deployed across a number of machines. In some example embodiments, the processors or processor-implemented engines may be located in a single geographic location (e.g., within a home environment, an office environment, or a server farm). In other example embodiments, the processors or processor-implemented engines may be distributed across a number of geographic locations.

Each process, method, and algorithm described in the preceding sections may be embodied in, and fully or partially automated by, code modules executed by one or more computer systems or computer processors comprising computer hardware. The processes and algorithms may be implemented partially or wholly in application-specific circuitry.

When the functions disclosed herein are implemented in the form of software functional units and sold or used as independent products, they can be stored in a processor executable non-volatile computer readable storage medium. Particular technical solutions disclosed herein (in whole or in part) or aspects that contribute to current technologies may be embodied in the form of a software product. The software product may be stored in a storage medium, comprising a number of instructions to cause a computing device (which may be a personal computer, a server, a network device, and the like) to execute all or some steps of the methods of the embodiments of the present application. The storage medium may comprise a flash drive, a portable hard drive, ROM, RAM, a magnetic disk, an optical disc, another medium operable to store program code, or any combination thereof.

Particular embodiments further provide a system comprising a processor and a non-transitory computer-readable storage medium storing instructions executable by the processor to cause the system to perform operations corresponding to steps in any method of the embodiments disclosed above. Particular embodiments further provide a non-transitory computer-readable storage medium configured with instructions executable by one or more processors to cause the one or more processors to perform operations corresponding to steps in any method of the embodiments disclosed above.

Embodiments disclosed herein may be implemented through a cloud platform, a server or a server group (hereinafter collectively the “service system”) that interacts with a client. The client may be a terminal device, or a client registered by a user at a platform, wherein the terminal device may be a mobile terminal, a personal computer (PC), and any device that may be installed with a platform application program.

The various features and processes described above may be used independently of one another or may be combined in various ways. All possible combinations and sub-combinations are intended to fall within the scope of this disclosure. In addition, certain method or process blocks may be omitted in some implementations. The methods and processes described herein are also not limited to any particular sequence, and the blocks or states relating thereto can be performed in other sequences that are appropriate. For example, described blocks or states may be performed in an order other than that specifically disclosed, or multiple blocks or states may be combined in a single block or state. The example blocks or states may be performed in serial, in parallel, or in some other manner. Blocks or states may be added to or removed from the disclosed example embodiments. The exemplary systems and components described herein may be configured differently than described. For example, elements may be added to, removed from, or rearranged compared to the disclosed example embodiments.

The various operations of exemplary methods described herein may be performed, at least partially, by an algorithm. The algorithm may be comprised in program codes or instructions stored in a memory (e.g., a non-transitory computer-readable storage medium described above). Such an algorithm may comprise a machine learning algorithm. In some embodiments, a machine learning algorithm may not explicitly program computers to perform a function but can learn from training data to make a prediction model that performs the function.

The various operations of exemplary methods described herein may be performed, at least partially, by one or more processors that are temporarily configured (e.g., by software) or permanently configured to perform the relevant operations. Whether temporarily or permanently configured, such processors may constitute processor-implemented engines that operate to perform one or more operations or functions described herein.

Similarly, the methods described herein may be at least partially processor-implemented, with a particular processor or processors being an example of hardware. For example, at least some of the operations of a method may be performed by one or more processors or processor-implemented engines. Moreover, the one or more processors may also operate to support performance of the relevant operations in a “cloud computing” environment or as a “software as a service” (SaaS). For example, at least some of the operations may be performed by a group of computers (as examples of machines including processors), with these operations being accessible via a network (e.g., the Internet) and via one or more appropriate interfaces (e.g., an Application Program Interface (API)).

The performance of certain of the operations may be distributed among the processors, not only residing within a single machine, but deployed across a number of machines. In some example embodiments, the processors or processor-implemented engines may be located in a single geographic location (e.g., within a home environment, an office environment, or a server farm). In other example embodiments, the processors or processor-implemented engines may be distributed across a number of geographic locations.

Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein.

Although an overview of the subject matter has been described with reference to specific example embodiments, various modifications and changes may be made to these embodiments without departing from the broader scope of embodiments of the present disclosure. Such embodiments of the subject matter may be referred to herein, individually or collectively, by the term “invention” merely for convenience and without intending to voluntarily limit the scope of this application to any single disclosure or concept if more than one is, in fact, disclosed.

The embodiments illustrated herein are described in sufficient detail to enable those skilled in the art to practice the teachings disclosed. Other embodiments may be used and derived therefrom, such that structural and logical substitutions and changes may be made without departing from the scope of this disclosure. The Detailed Description, therefore, is not to be taken in a limiting sense, and the scope of various embodiments is defined only by the appended claims, along with the full range of equivalents to which such claims are entitled.

Any process descriptions, elements, or blocks in the flow diagrams described herein and/or depicted in the attached figures should be understood as potentially representing modules, segments, or portions of code which include one or more executable instructions for implementing specific logical functions or steps in the process. Alternate implementations are included within the scope of the embodiments described herein in which elements or functions may be deleted, executed out of order from that shown or discussed, including substantially concurrently or in reverse order, depending on the functionality involved, as would be understood by those skilled in the art.

As used herein, “or” is inclusive and not exclusive, unless expressly indicated otherwise or indicated otherwise by context. Therefore, herein, “A, B, or C” means “A, B, C, A and B, A and C, B and C, or A, B, and C,” unless expressly indicated otherwise or indicated otherwise by context. Moreover, “and” is both joint and several, unless expressly indicated otherwise or indicated otherwise by context. Therefore, herein, “A and B” means “A and B, jointly or severally,” unless expressly indicated otherwise or indicated otherwise by context. Moreover, plural instances may be provided for resources, operations, or structures described herein as a single instance. Additionally, boundaries between various resources, operations, engines, and data stores are somewhat arbitrary, and particular operations are illustrated in a context of specific illustrative configurations. Other allocations of functionality are envisioned and may fall within a scope of various embodiments of the present disclosure. In general, structures and functionality presented as separate resources in the example configurations may be implemented as a combined structure or resource. Similarly, structures and functionality presented as a single resource may be implemented as separate resources. These and other variations, modifications, additions, and improvements fall within a scope of embodiments of the present disclosure as represented by the appended claims. The specification and drawings are, accordingly, to be regarded in an illustrative rather than a restrictive sense.

The term “include” or “comprise” is used to indicate the existence of the subsequently declared features, but it does not exclude the addition of other features. Conditional language, such as, among others, “can,” “could,” “might,” or “may,” unless specifically stated otherwise, or otherwise understood within the context as used, is generally intended to convey that certain embodiments include, while other embodiments do not include, certain features, elements and/or steps. Thus, such conditional language is not generally intended to imply that features, elements and/or steps are in any way required for one or more embodiments or that one or more embodiments necessarily include logic for deciding, with or without user input or prompting, whether these features, elements and/or steps are included or are to be performed in any particular embodiment.

What is claimed is:

1. A computing system, comprising:
a reconfigurable logic device comprising a plurality of reconfigurable regions;
a power management circuit coupled to the reconfigurable logic device and configured to independently control power to respective ones of the plurality of reconfigurable regions; and
a controller coupled to the power management circuit, wherein the controller is configured to:
determine, based on at least one of a task indication, a workload condition, or a control command, a subset of the plurality of reconfigurable regions to be powered, and
cause the power management circuit to supply power to each reconfigurable region in the subset and to withhold power from at least one reconfigurable region outside the subset.

2. The system of claim 1, wherein the reconfigurable logic device comprises a field-programmable gate array (FPGA).

3. The system of claim 1, wherein the controller comprises a complex programmable logic device (CPLD).

4. The system of claim 1, wherein the power management circuit comprises a power management integrated circuit (PMIC) having a plurality of controllable power outputs respectively associated with the plurality of reconfigurable regions.

5. The system of claim 1, wherein the controller is configured to:
determine, based on a target configuration bitstream associated with a target task, an initial subset of the plurality of reconfigurable regions to be powered; and
during execution of the target task, refine the initial subset based on telemetry data by causing the power management circuit to withhold power from at least one reconfigurable region that is included in the initial subset.

6. The system of claim 1, wherein to determine the subset of the plurality of reconfigurable regions to be powered, the controller is configured to:
determine a target task based on a predefined task list stored in a non-volatile configuration memory accessible to the controller or based on an external command received by the controller;
select a target configuration bitstream associated with the target task;
determine, based on the target configuration bitstream, the subset of the plurality of reconfigurable regions; and
load the target configuration bitstream to the reconfigurable logic device.

7. The system of claim 1, wherein the controller is coupled to the reconfigurable logic device via an inter-integrated circuit (I²C) interface or a serial peripheral interface (SPI), and
the controller is configured to:
determine a target task based on task status information received from the reconfigurable logic device via the I²C interface or the SPI;
select a target configuration bitstream associated with the target task;
determine, based on the target configuration bitstream, the subset of the plurality of reconfigurable regions; and
load the target configuration bitstream to the reconfigurable logic device.

8. The system of claim 1, further comprising one or more sensors configured to provide telemetry data comprising at least one of current or temperature associated with the reconfigurable logic device,
wherein the controller is configured to determine the subset of the plurality of reconfigurable regions based on the telemetry data.

9. The system of claim 8, wherein the one or more sensors comprise a plurality of current sensors respectively associated with the plurality of reconfigurable regions, and
wherein the controller is configured to:
determine, based on region-level current values from the plurality of current sensors, whether to power a respective reconfigurable region.

10. The system of claim 8, wherein the one or more sensors comprise a plurality of temperature sensors disposed around a periphery of the reconfigurable logic device,
wherein the controller is configured to determine, based on temperature data from the plurality of temperature sensors, whether the reconfigurable logic device is executing a workload condition indicative of an active task, and
wherein the controller is configured to determine the subset of the plurality of reconfigurable regions to be powered based at least in part on the workload condition.

11. The system of claim 1, wherein the controller is configured to:
switch from a first subset associated with a first task to a second subset associated with a second task by causing the power management circuit to remove power from at least one reconfigurable region in the first subset and to supply power to at least one reconfigurable region in the second subset.

12. The system of claim 1, further comprising a non-volatile configuration memory storing a plurality of configuration bitstreams for the reconfigurable logic device, and
wherein the reconfigurable logic device further comprises an on-chip configuration cache configured to:
store one or more configuration fragments associated with at least one of the plurality of configuration bitstreams,
wherein the controller is configured, during a task switch, to cause at least one configuration fragment to be loaded from the on-chip configuration cache.

13. The system of claim 4, wherein the PMIC is configured to output a power-good indication for a reconfigurable region after a power rail for the reconfigurable region satisfies a stability criterion,
wherein the controller is configured to delay loading configuration data for the reconfigurable region until receipt of the power-good indication.

14. A computer-implemented method, comprising:
determining, by a controller, a target task based on at least one of a task indication, a workload condition, or a control command;
selecting, by the controller, a target configuration bitstream associated with the target task;
determining, based on the target configuration bitstream, a subset of a plurality of reconfigurable regions of a reconfigurable logic device to be powered;
causing, by the controller, a power management circuit having a plurality of controllable power outputs respectively associated with the plurality of reconfigurable regions to supply power to each reconfigurable region in the subset and to withhold power from at least one reconfigurable region outside the subset; and
responsive to receiving a power-good indication for at least one reconfigurable region in the subset, loading at least a portion of the target configuration bitstream to the reconfigurable logic device.

15. The method of claim 14, wherein determining the target task comprises:
determining the target task based on a predefined task list stored in a non-volatile configuration memory accessible to the controller or based on an external command received by the controller.

16. The method of claim 14, wherein determining the target task comprises:
receiving, from the reconfigurable logic device via an inter-integrated circuit (I²C) interface or a serial peripheral interface (SPI), task status information indicative of the target task.

17. The method of claim 14, further comprising:
during execution of the target task, receiving telemetry data comprising at least one of region-level current or temperature associated with the reconfigurable logic device; and
based on the telemetry data, causing the power management circuit to withhold power from at least one reconfigurable region included in the subset.

18. A non-transitory computer-readable medium storing instructions that, when executed by one or more processors of a controller, cause the controller to perform operations comprising:
determining a target task based on at least one of a task indication, a workload condition, or a control command;
selecting a target configuration bitstream associated with the target task;
determining, based on the target configuration bitstream, a subset of a plurality of reconfigurable regions of a reconfigurable logic device to be powered;
causing a power management circuit having a plurality of controllable power outputs respectively associated with the plurality of reconfigurable regions to supply power to each reconfigurable region in the subset and to withhold power from at least one reconfigurable region outside the subset; and
responsive to receiving a power-good indication for at least one reconfigurable region in the subset, loading at least a portion of the target configuration bitstream to the reconfigurable logic device.

19. The non-transitory computer-readable medium of claim 18, wherein determining the target task comprises:
receiving task status information from the reconfigurable logic device via an inter-integrated circuit (I²C) interface or a serial peripheral interface (SPI); and
determining the target task based at least in part on the task status information, alone or in combination with telemetry data comprising at least one of current or temperature associated with the reconfigurable logic device.

20. The non-transitory computer-readable medium of claim 18, wherein the operations further comprise:
switching from a first task associated with a first configuration bitstream and a first subset of the plurality of reconfigurable regions to a second task associated with a second configuration bitstream and a second subset of the plurality of reconfigurable regions by:
causing the power management circuit to remove power from at least one reconfigurable region in the first subset;
causing the power management circuit to supply power to at least one reconfigurable region in the second subset; and
loading at least a portion of the second configuration bitstream to the reconfigurable logic device.
